(19) United States
(12) Patent Application Publication
(10) Pub. No.: US 2014/0189031 A1
(43) Pub. Date: Jul. 3, 2014

(54) COMPUTING DEVICE AND METHOD OF CREATING VIRTUAL MACHINES IN HOSTS

(71) Applicant: HON HAI PRECISION INDUSTRY CO., LTD., New Taipei (TW)

(72) Inventors: CHUNG-I LEE, New Taipei (TW); CHIU-HUA LU, New Taipei (TW); TSUNG-HSIN YEN, New Taipei (TW); CHIEN-CHIH LIN, New Taipei (TW)

(73) Assignee: HON HAI PRECISION INDUSTRY CO., LTD., New Taipei (TW)

(21) Appl. No.: 13/947,146

(22) Filed: Jul. 22, 2013

(30) Foreign Application Priority Data
Dec. 27, 2012 (TW) 101150614

(51) Int. Cl. H04L 29/08

(52) U.S. Cl. CPC H04L 29/08243
USPC 709/212

(57) ABSTRACT

A method creates one or more virtual machine (VM) templates, and stores the one or more templates in a storage device. When one host requests to create a VM, the system selects a VM template from the storage device according to a hardware specification of the requested VM, copies hardware configuration information recorded in the selected VM template, and creates the VM in the host according to the copied information. The method requests a dynamic host configuration protocol (DHCP) server to allocate an IP address to the VM via a DHCP agent, and assigns the IP address allocated by the DHCP server to the VM via a host agent.

### BACKGROUND

1. Technical Field

Embodiments of the present disclosure relate to virtualization technology, and more particularly to a method for creating virtual machines in hosts.

2. Description of Related Art

Virtual machines (VM) are software implementations that create one or more VMs in a host. A guest operating system (OS) is a virtualized environment, multiple guest OSes can co-exist and run independently on the same host. In a process of establishing a virtualization environment, a large number of VMs may be created. However, creation of the VMs is often done by allocating configuration information (such as hardware resources and network resources) to each VM one by one, which is repetitive and time-consuming. Therefore, there is room for improvement in the art.

### BRIEF DESCRIPTION OF THE DRAWINGS

FIG. 1 is a block diagram of one embodiment of a VM creation system.

FIG. 2 is a block diagram of one embodiment of function modules of the VM creation system in FIG. 1.

FIG. 3 is a flowchart of one embodiment of a method of creating VMs in hosts.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

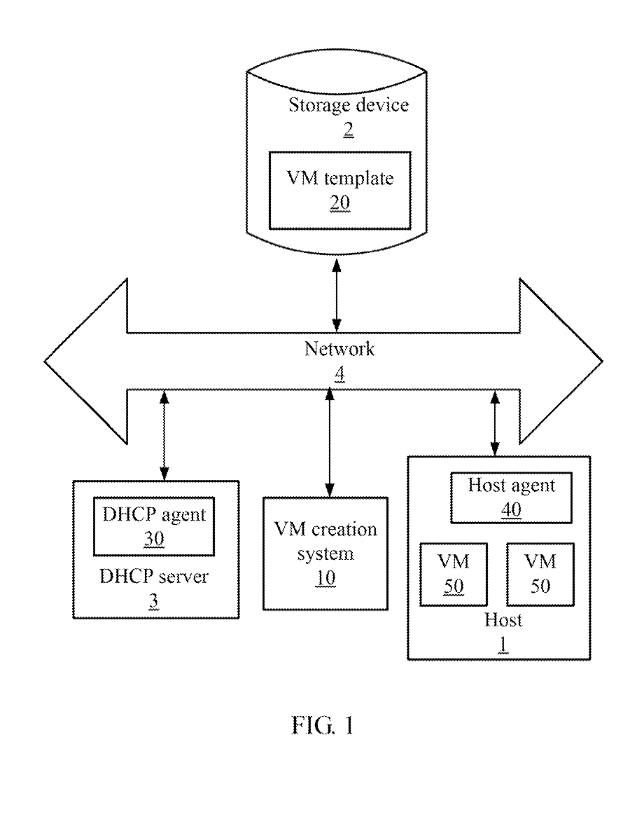

FIG. 1 is a block diagram of one embodiment of an application environment of a virtual machine creation system 10 (hereinafter the “system 10”). One or more hosts 1 (only one shown) are electronically connected to a storage device 2 and a dynamic host configuration protocol (DHCP) server 3 via a network 4. The system 10 may be installed in each of the one or more hosts 1, or the DHCP server 3, or any other physical computing device (e.g., a server) independent from the DHCP server 3 and the one or more hosts 1.

In one embodiment, the DHCP server 3 includes a DHCP agent 30, and each host 1 includes a host agent 40. The system 10 creates one or more VM templates 20, and stores the one or more templates 20 in the storage device 2. A VM template 20 is a file that contains hardware configuration information for creating one type of VMs 50. When a request to create a virtual machine (VM) 50 is issued by a host 1, the system 10 selects a VM template 20 from the storage device 2, copies hardware configuration information recorded in the VM template 20, and creates the VM 50 in the host 1 according to the copied information. Furthermore, the system 10 reqests the DHCP server 3 to allocate an IP address to the VM 50 via the DHCP agent 30, and assigns the IP address allocated by the DHCP server 3 to the VM 50 via the host agent 40.

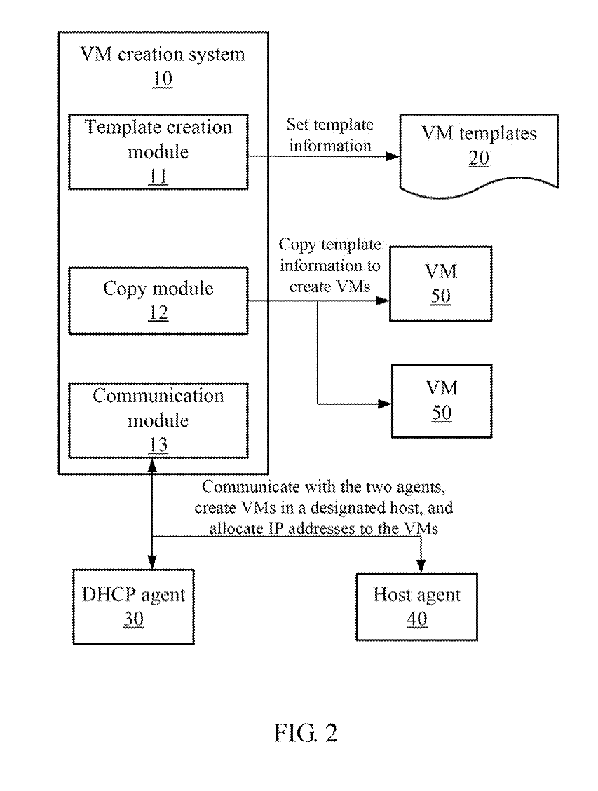

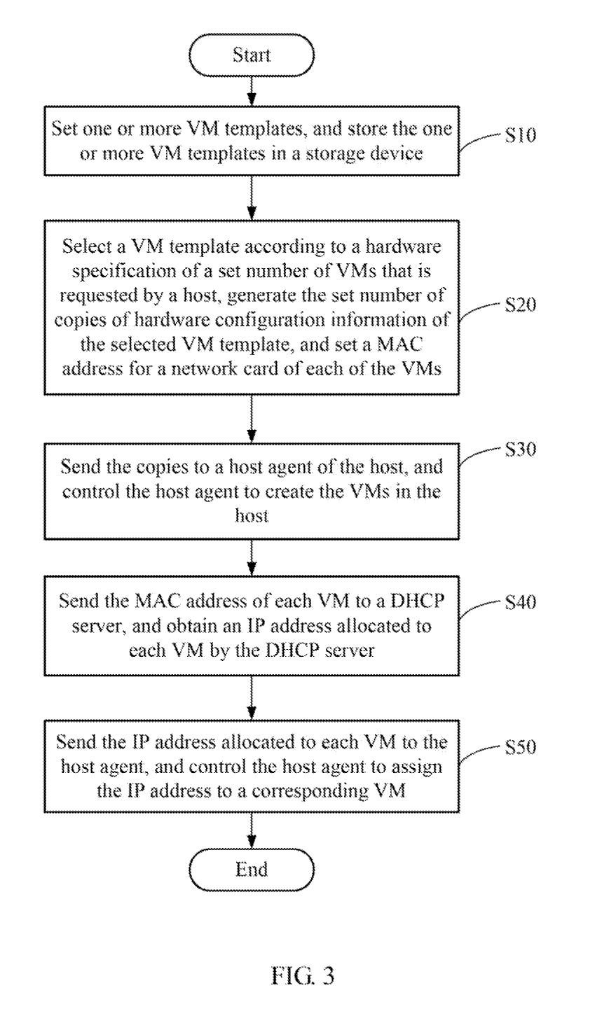

As shown in FIG. 2, the system 10 includes a plurality of function modules, such as a template creation module 11, a copy module 12, and a communication module 13. The modules 11-13 include computerized code in the form of one or more programs, which include instructions. The one or more programs may be stored in the storage device 2, or stored in a non-transitory storage device of the computing device in which the system 10 is installed. A processor of the computing device in which the system 10 is installed executes the instructions, to provide the aforementioned functions of the system 10. Detailed functions of the modules 11-14 are given in reference to FIG. 2 and FIG. 3.

FIG. 3 is a flowchart of one embodiment of a method of creating VMs in the hosts 1. Depending on the embodiment, additional steps may be added, others removed, and the ordering of the steps may be changed.

In step S10, the template creation module 11 creates a VM template 20. In one embodiment, creation of the VM template 20 includes setting hardware configuration information for creating a VM 50. The hardware configuration information includes CPU information, memory information, hard disk information and network card information. For example, the CPU information includes a number of CPU cores to be allocated to the VM 50, the memory information includes a capacity of memory space to be allocated to the VM 50, the hard disk information includes a capacity of hard disk space to be allocated to the VM 50, and the network card information includes a network card type and a number of network cards to be allocated to the VM 50. VM templates 20 with different hardware configuration information may be created by the VM template creation module 11 and stored into the storage device 2.

In step S20, when the system 10 receives a request (e.g., the request may be sent by a host 1) of creating a set number of VMs 50 and a hardware specification of the number of VMs 50, the copy module 12 selects a VM template 20 from the storage device 2 based on the request. Furthermore, the copy module 12 generates the set number of copies of hardware configuration information from the VM template 20, and sets a media access control (MAC) address for a network card of each the VMs 50. In one embodiment, the set number is a natural number, such as one or more. For example, if three VMs 50 with the hardware configuration information of “one CPU core, 2G memory, 100G hard disk, and one network card” are requested and a corresponding VM template 20 is selected, the copy module 12 generates three copies of the hardware configuration information recorded in the selected VM template for the three VMs 50, and sets a MAC address for the network card of each of the three VMs 50.

In step S30, the communication module 13 sends the copies of hardware configuration information to a host agent 40 of the host 1, and controls the host agent 40 to create the VMs 50 in the host 1. For example, the three VMs 50 with the hardware configuration information “one CPU core, 2G memory, 100G hard disk, and one network card” are created in the host 1.

In step S40, the communication module 13 sends the MAC address of each created VM 50 to the DHCP server 3, and obtains an IP address allocated to the created VM 50 by registering the MAC address of the created VM 50 to the DHCP agent 30 of the DHCP server 3. Each IP address allocated to the created VM 50 by the DHCP server 3 is associated with the MAC address of the created VM 50.

In step S50, the communication module 13 sends the IP addresses allocated to the created VMs 50 to the host agent 40 of the host 1, and controls the host agent 40 to assign each of the IP addresses to a corresponding created VM 50. As mentioned above, each IP address allocated to a created VM 50 is associated with the MAC address of the created VM 50, so that the host agent 40 may determine a MAC address of a VM 50 that should be assigned the IP address according to an association between the IP address and the MAC address, and searches the VM 50 in the host 1 according to the MAC address. In addition, the communication module 13 may further control operations of the created VMs 50 via the host agent 40. For example, the operations may include deleting, shutting down, or restarting a VM 50.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of a computing device, the method comprising:
creating one or more virtual machine (VM) templates and storing the one or more VM templates into a storage device, wherein the creation of each VM template comprising setting hardware configuration information for creating a VM;
when receiving a request of creating a set number of VMs sent from a host, selecting a VM template from the storage device according to a hardware specification of the requested VMs, generating the set number of copies of hardware configuration information of the selected VM template, and setting a media access control (MAC) address for a network card of each of the VMs;
sending the copies of hardware configuration information to a host agent of the host, and creating the VMs in the host by controlling the host agent;
sending MAC addresses of the VMs to a dynamical host configuration protocol (DHCP) server, and obtaining an IP address allocated to each of the VMs by registering each of the MAC addresses to a DHCP agent of the DHCP server; and
sending IP addresses allocated to the VMs to the host agent of the host, and assigning each of the IP addresses to a corresponding VM by controlling the host agent.

2. The method as claimed in claim 1, wherein the hardware configuration information comprises CPU information, memory information, hard disk information and network card information.

3. The method as claimed in claim 1, wherein each IP address allocated to a VM is associated with the MAC address of the VM.

4. The method as claimed in claim 3, wherein the host agent determines a MAC address of the VM that should be assigned the IP address according to an association between the IP address and the MAC address, and searches the VM in the host according to the MAC address.

5. The method as claimed in claim 1, wherein the storage device is a non-transitory storage device of the host or a network storage device.

6. The method as claimed in claim 1, wherein the computing device is the DHCP server or the host.

7. A non-transitory computer-readable medium having stored thereon instructions that, when executed by at least one processor of a computing device, cause the at least one processor to perform operations of:
creating one or more virtual machine (VM) templates and storing the one or more VM templates into a storage device, wherein the creation of each VM template comprising setting hardware configuration information for creating a VM;
when receiving a request of creating a set number of VMs sent from a host, selecting a VM template from the storage device according to a hardware specification of the requested VMs, generating the set number of copies of hardware configuration information of the selected VM template, and setting a media access control (MAC) address for a network card of each of the VMs;
sending the copies of hardware configuration information to a host agent of the host, and creating the VMs in the host by controlling the host agent;
sending MAC addresses of the VMs to a dynamical host configuration protocol (DHCP) server, and obtaining an IP address allocated to each of the VMs by registering each of the MAC addresses to a DHCP agent of the DHCP server; and
sending IP addresses allocated to the VMs to the host agent of the host, and assigning each of the IP addresses to a corresponding VM by controlling the host agent.

8. The medium as claimed in claim 7, wherein the hardware configuration information comprises CPU information, memory information, hard disk information and network card information.

9. The medium as claimed in claim 7, wherein each IP address allocated to a VM is associated with the MAC address of the VM.

10. The medium as claimed in claim 9, wherein the host agent determines a MAC address of the VM that should be assigned the IP address according to an association between the IP address and the MAC address, and searches the VM in the host according to the MAC address.

11. The medium as claimed in claim 1, wherein the storage device is a non-transitory storage device of the host or a network storage device.

12. The medium as claimed in claim 7, wherein the computing device is the DHCP server or the host.

13. A computing device, comprising:
at least one processor; and
a storage device that stores instructions, when executed by at least one processor of a computing device, cause the at least one processor to perform operations of:
creating one or more virtual machine (VM) templates and storing the one or more VM templates into a storage device, wherein the creation of each VM template comprising setting hardware configuration information for creating a VM;
when receiving a request of creating a set number of VMs sent from a host, selecting a VM template from the storage device according to a hardware specification of the requested VMs, generating the set number of copies of hardware configuration information of the selected VM template, and setting a media access control (MAC) address for a network card of each of the VMs;
sending the copies of hardware configuration information to a host agent of the host, and creating the VMs in the host by controlling the host agent;
sending MAC addresses of the VMs to a dynamical host configuration protocol (DHCP) server, and obtaining an IP address allocated to each of the VMs by registering each of the MAC addresses to a DHCP agent of the DHCP server; and
sending IP addresses allocated to the VMs to the host agent of the host, and assigning each of the IP addresses to a corresponding VM by controlling the host agent.

14. The computing device as claimed in claim 13, wherein the hardware configuration information comprises CPU information, memory information, hard disk information and network card information.

15. The computing device as claimed in claim 13, wherein each IP address allocated to a VM is associated with the MAC address of the VM.

16. The computing device as claimed in claim 15, wherein the host agent determines a MAC address of the VM that should be assigned the IP address according to an association between the IP address and the MAC address, and searches the VM in the host according to the MAC address.

17. The computing device as claimed in claim 13, wherein the storage device is a non-transitory storage device of the host or a network storage device.
